(19) United States
(12) Patent Application Publication
(10) Pub. No.: US 2010/0270045 A1
(43) Pub. Date: Oct. 28, 2010

(54) HANDHELD POWER TOOL

(76) Inventor: Andre Ullrich, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/809,920

(22) PCT Filed: Nov. 3, 2008
(86) PCT No.: PCT/EP08/64854

§ 371 Date: Jun. 21, 2010

(30) Foreign Application Priority Data
Dec. 21, 2007 (DE) 10 2007 062 260.2

(51) Int. Cl. B25F 5/00

(52) U.S. Cl. 173/47

(57) ABSTRACT

The invention relates to a portable power tool, in particular a boring and/or chisel hammer, with an intermediate flange and a gear unit which has switch mounted on the intermediate flange. It is proposed that the switch be provided to switch at least three gear stages of the gear unit.

### PRIOR ART

The invention is based on a handheld power tool as generically defined by the preamble to claim 1.

A handheld power tool with an intermediate flange and a gear unit in which a switch means is disposed on the intermediate flange is already known.

Advantages of the Invention

The invention is based on a handheld power tool, in particular a rotary and/or chiseling hammer, having an intermediate flange and a gear unit which has a switch means supported on the intermediate flange.

It is proposed that the switch means is provided for switching among at least three gear stages of the gear unit. In this connection, the term “gear unit” should be understood in particular to mean a unit which has movable connections of parts and which is provided for transmitting and/or converting a force and/or a torque and/or for guiding parts. An “intermediate flange” here in particular defines a component that is provided for supporting drive elements, such as a motor shaft, a hammer tube, an intermediate shaft, and/or other gear elements that appear useful to the person skilled in the art. The intermediate flange can also be embodied in one piece with a handheld power tool housing. The term “switch means” should be understood here in particular to mean a key, a toggle switch, a spring, and/or especially advantageously a lever. However, some other means that appears useful to the person skilled in the art would also be possible. A “gear stage” here defines a special arrangement of components of a gear mechanism; the various gear stages are provided for operation of the handheld power tool in different modes of operation, such as drilling, impact drilling and/or chiseling, in particular. As a result of the embodiment according to the invention, user-friendly manipulation of the handheld power tool can be furnished, and the handheld power tool can furthermore be embodied with a compact structure in a way that economizes on components and is economical.

It is also proposed that the gear unit has at least one switch bush, which is movable by means of the switch means. In this connection, a “switch bush” should be understood in particular to mean a cylindrical body, which is supported on a shaft, in particular an intermediate shaft, and/or is guided thereby, and/or is provided for being able to be associated with at least one of the modes of operation. As a result of the realization of the switch bush, switching among the modes of operation can be done structurally simply. Advantageously, the gear unit has a further switch bush, as a result of which at least two modes of operation can be decoupled from one another in a structurally simple way.

It may also be advantageous that the two switch bushes are supported on one shaft. The term “shaft” should be understood in this connection to mean in particular an element that is provided for transmitting a rotary motion and/or forces and/or for supporting components. The components can be disposed on the shaft in a manner fixed against relative rotation. Moreover, the shaft can be decoupled by a connection means into two shaft segments. Preferably, the shaft is formed by an intermediate shaft, but it is also conceivable to design it as some other kind of shaft that appears expedient to the person skilled in the art. Because of the common supporting of the switch bushes on the same shaft, switching among the gear stages can be achieved in a compact and structurally simple way.

It is also advantageous if at least one of the switch bushes is supported movably in an axial direction that extends parallel to a longitudinal extent of the intermediate shaft. As a result of the movable support, coupling and/or decoupling of the gear stages can be accomplished in a space-saving way.

In a further feature of the invention, the switch means has a contact region for application of an actuating element. The term “contact region” should be understood in particular to mean a region, for instance having a groove, an extension, a thread, and/or some other coupling formation which appears expedient to one skilled in the art, and on which a component, such as an actuating element, can be connected to the switch means effectively, in particular by positive, nonpositive, and/or material engagement. In this connection, an actuating element should be understood in particular to be an element, such as a key, lever, toggle switch, and/or especially advantageously a rotary switch, that can be operated by a user, preferably on an outer side of a housing of the handheld power tool. As a result of the embodiment according to the invention, operation of a gear mechanism can be designed to be simple and user-friendly.

It is also proposed that the handheld power tool has a bearing point, which is provided for a rotational support of the switch means on the intermediate flange. The term “bearing point” should be understood in particular to mean a point, such as a contact point and/or a recess, that defines a tilt axis, axis of rotation, and/or pivot axis of the switch means. The switch means can be moved relative to a component, the component for instance being disposed along the tilt axis, axis of rotation and/or pivot axis, and can be disposed as tiltable and/or rotatable and/or pivotable relative to that component. Moreover, the term “provided” should be understood to mean especially equipped and/or designed. Because of how the bearing point is realized, a short switching path can be furnished in a structurally simple way.

A spacer-saving arrangement can advantageously be achieved if the switch means engages an intermediate space between the two switch bushes. The term “intermediate space” should be understood here to mean in particular a region that is located, in a direction, preferably an axial direction, of the handheld power tool, between two components, such as the switch bushes, and/or that keeps the components spaced apart from one another in at least one mode of operation. Preferably, the intermediate space is filled with air. As a result of the engagement of the switch means with the intermediate space, a single switch means can advantageously and in a component-economizing way be used for switching among three gear stages.

It is also proposed that an engagement with the intermediate space takes place without force in at least one gear stage. The term “without force” should be understood in particular to mean that the switch means is in the state of engagement with the intermediate space in a position of equilibrium, in which no forces act, particularly in the axial direction, on the switch means. As a result, in a structurally simple way, a low-wear position of the switch means in a gear stage, preferably in the gear stage for impact drilling, can be attained.

A preferred refinement is that the handheld power tool has a spring unit, which is provided for acting upon a switch bush with a spring force in at least one mode of operation. In this connection, the term “spring unit” should be understood in particular to mean a unit having at least one spring, in which the spring serves to store energy that can be converted into a motion, in particular a motion of other components, such as a switch bush. The spring is preferably embodied as a helical spring, but some other spring would also be conceivable, such as a leaf spring, torsion spring, cup spring, and/or some other spring that appears useful to the person skilled in the art. By means of the spring unit, a switching force can be stored in a structurally simple way, and low-wear switching of components of the gear unit can be attained.

It is furthermore proposed that the spring force, in at least one mode of operation, acts counter to a switching force. The term “switching force” should be understood here to mean in particular a force which must be expended, particularly by a user, for a switching motion of the switch means and/or of one of the switch bushes. By means of the embodiment according to the invention, it is possible in a structurally simple way, upon a release of a switching path of a switchable component, such as the switch bush in particular, to move that component back into an outset position.

### DRAWINGS

Further advantages will become apparent from the ensuing description of the drawings. In the drawings, one exemplary embodiment of the invention is shown. The drawings, description and claims include numerous characteristics in combination. One skilled in the art will expediently consider the characteristics individually as well and put them together to make useful further combinations.

Shown are:

FIG. 1, a schematic illustration of a handheld power tool;

FIG. 2, the gear unit of the handheld power tool of FIG. 1, in an impact drilling mode;

FIG. 3, a detailed view of FIG. 2;

FIG. 4, the gear unit of the handheld power tool of FIG. 1 in an impact mode in a detailed view; and

FIG. 5, the gear unit of the handheld power tool of FIG. 1 in a drilling mode in a detailed view.

### DESCRIPTION OF THE EXEMPLARY EMBODIMENT

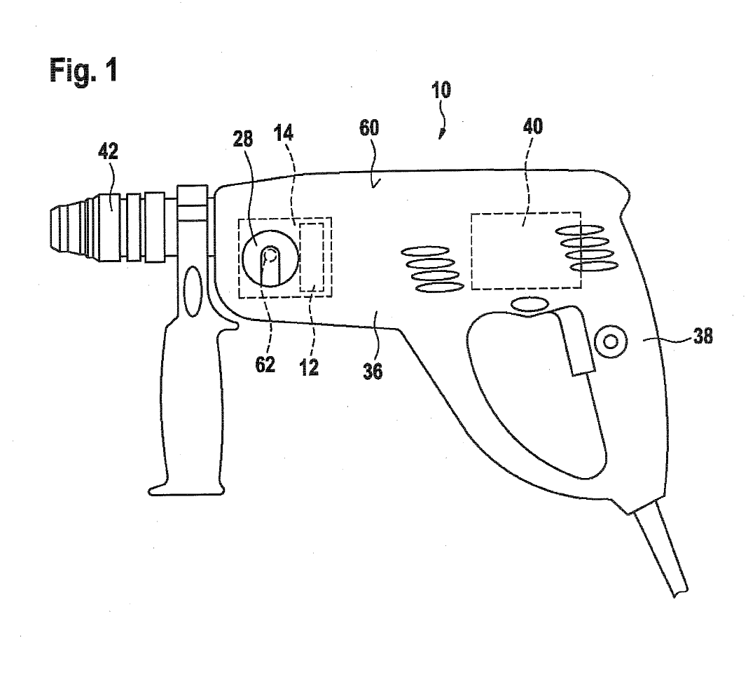

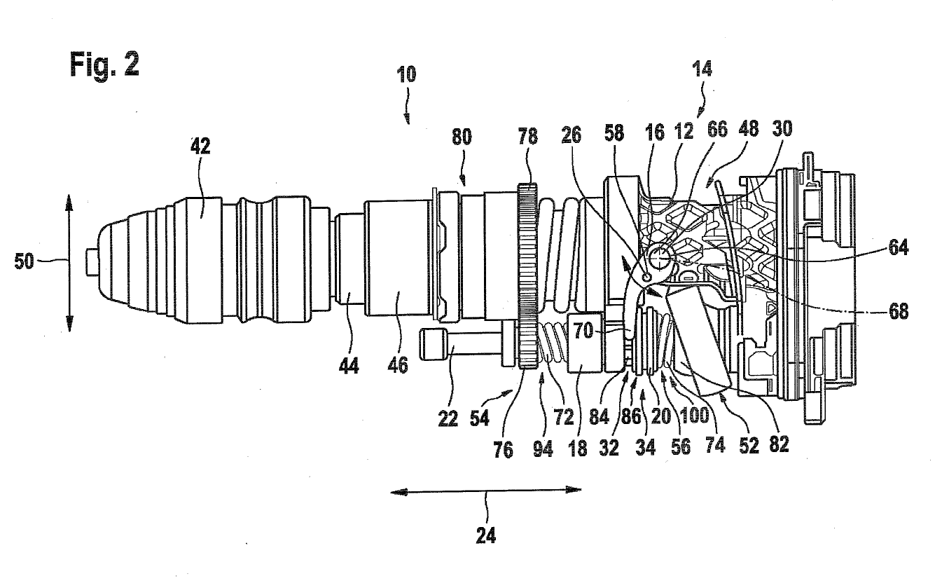

FIG. 1 shows a handheld power tool 10 of the invention in the form of a drill hammer, having a housing 36, a main handle 38, and a motor unit 40. Also disposed in the housing 36 are an intermediate flange 12 and a gear unit 14, and the gear unit 14 has a switch means 16, which is supported on the intermediate flange 12 and is provided for switching among at least three gear stages of the gear unit 14 (see FIGS. 2 through 5).

In FIG. 2, a portion of the handheld power tool 10 is shown. In the housing 36, not shown in FIG. 2, the intermediate flange 12 and the gear unit 14 are disposed and supported in an axial direction 24 between the motor unit 40, not shown, and a tool holder 42.

A driving torque of the motor unit 40 is transmitted (not shown) via a drive shaft and two gear wheels, meshing with one another, to a shaft 22, in the form of an intermediate shaft, as a result of which a power takeoff tube 44, which is connected in a manner fixed against relative rotation to a hammer tube 46, is driven rotationally, and a impact mechanism 48 is driven translationally. A tool bit not shown in further detail here is disposed in the tool holder 42 and, in a drilling mode of the gear unit 14, it is rotated by means of a rotationally fixed coupling of the tool holder 42 and the power takeoff tube 44. The shaft 22 extends parallel to the hammer tube 46 and extends below the hammer tube 46 as viewed in the vertical direction 50.

The impact mechanism 48 has a tumbling gear 52, supported on the shaft 22, and a striking element, which is guided movably in the axial direction 24 in the power takeoff tube 44 and imparts its impact energy, for instance via an air cushion, to an impact means and thereby to the axially displaceably supported tool (this action is not shown).

The gear unit 14 furthermore has a switch bush 18 and a further switch bush 20, which are movable by means of the switch means 16. The two switch bushes 18, 20 are supported movably in the axial direction 24 on the shaft 22. The switch bush 18 is disposed in a region 54 of the shaft 22 oriented toward the tool holder 42, and the switch bush 20 is disposed in a region 56 oriented toward the tumbling gear 52.

The switch means 16 is disposed on the intermediate flange 12 and has a contact region 26, in the form of a recess 58, for applying an actuating element 28. The actuating element 28 is disposed on an outside 60 of the housing 36 and, with a connection unit not shown in detail, it reaches through a recess 62 in the housing 36 into the contact region 26 or into the recess 58 of the switch means 16 by positive engagement (see also FIG. 1). Moreover, the switch means 16 has a bearing point 30, in the form of a recess 64, which is provided for a rotational support of the switch means 16 on the intermediate flange 12. A connecting element 66, which defines an axis 68 about which the switch means 16 can be pivoted, is placed in the recess 64.

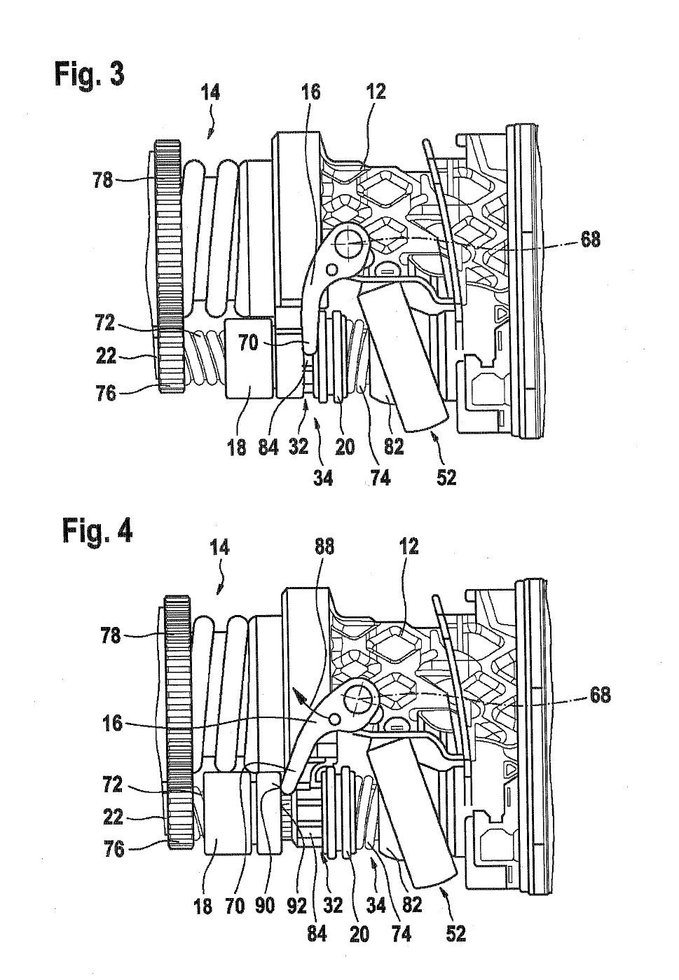

In an impact drilling mode of the handheld power tool 10 or gear unit 14, which mode is shown in FIGS. 2 and 3, the switch means 16, with an extension 70 that extends from the recess 58 in the direction of the shaft 22, engages an intermediate space 32 between the two switch bushes 18, 20, and an engagement with the intermediate space 32 takes place without force. The gear unit 14 furthermore has a spring unit 34, which includes two springs 72 and 74 and is provided for exerting a spring force on the switch bushes 18, 20 in the impact drilling mode, or on the switch bush 18 in the drilling mode, or on the switch bush 20 in the chiseling mode.

The spring 72 is disposed in the axial direction 24 between the switch bush 18 and a transmission gear wheel 76, connected to the shaft 22 in a manner fixed against relative rotation, and is braced by each of its axial ends on the switch bush 18 and the transmission gear wheel 76, respectively. The transmission gear wheel 76 is supported fixedly on the shaft 22 in an axial direction of the shaft 22 that extends parallel to the axial direction 24, in the region 54 of the shaft 22 oriented toward the tool holder 42, and meshes with a gear wheel 78 that transmits a rotary motion of the shaft 22 to the hammer tube 46 or to the tool holder 42 and thus to the tool. The gear wheel 78 is disposed rotatably on the hammer tube 46 and is operatively connected to it via an overload clutch 80.

The spring 74 is disposed in the axial direction 24 between the switch bush 20 and a bearing body 82, supported on the shaft 22, of the tumbling gear 52, and is braced by each of its axial ends on the switch bush 20 and on the bearing body 82, respectively. In the gear stage of impact drilling of the gear unit 14, the springs 72, 74 act with a spring force on the switch bushes 18, 20, as a result of which the switch bushes 18, 20, with their sets of inner teeth, not shown in detail, are pressed into engagement with a rotary slaving contour 84, which forms a connection means of the shaft 22. The shaft 22 has two shaft segments 94 and 100, which are joined via a component that has the rotary slaving contour 84. The rotor slaving contour 84 is connected to the shaft 22 in a manner fixed against relative rotation and axially fixedly to a region 86 which is disposed in the intermediate space 32. The rotary slaving contour 84 may be disposed on a separate component, which is secured to the region 86 of the shaft 22 in a manner fixed against relative rotation, or it may be integrated with one of the shaft segments 94 and/or 100.

In FIG. 4, a chiseling position of the gear unit 14 of the handheld power tool 10 is shown. To switch the gear unit 14 of the handheld power tool 10 from the impact drilling position shown in FIGS. 2 and 3 to a gear position in which the gear unit 14 furnishes solely a chiseling mode, the switch means 16 is pivoted, via the actuating element 28 not shown here, about the axis 68 in a direction of rotation 88, that is, clockwise. As a result of this pivoting motion, the switch means 16 is moved out of its position of equilibrium, and a surface 90 of the extension 70 comes into contact with a surface 92 of the switch bush 18. By means of a thus-exerted contact pressure, the switch bush 18 is moved in the axial direction 24, counter to the spring force of the spring 72, on the shaft 22 in the direction of the transmission gear wheel 76, as a result of which the spring 72 is compressed, and the set of inner teeth of the switch bush 18 becomes disengaged from the rotary slaving contour 84. Thus the shaft region 94 of the shaft 22 (see FIG. 2) is decoupled from a rotary motion of the drive shaft, and no transmission of the torque to the hammer tube 46 or the tool holder 42 and to the tool takes place. An engagement of the switch bush 20 remains unaffected, as a result of which the translational torque transmission to the tumbling gear 52 continues to take place, and a chiseling mode of the gear unit 14 is made possible.

If the switch means 16, by actuation of the actuating element 28, is pivoted back into the impact drilling gear stage or into its position of equilibrium (see FIGS. 2 and 3), then because the spring force of the spring 72 acts counter to a switching force of the switch means 16, the switch bush 18 is displaced in the axial direction 24 in the direction of the switch bush 20 and enters again into engagement with the rotary slaving contour 84.

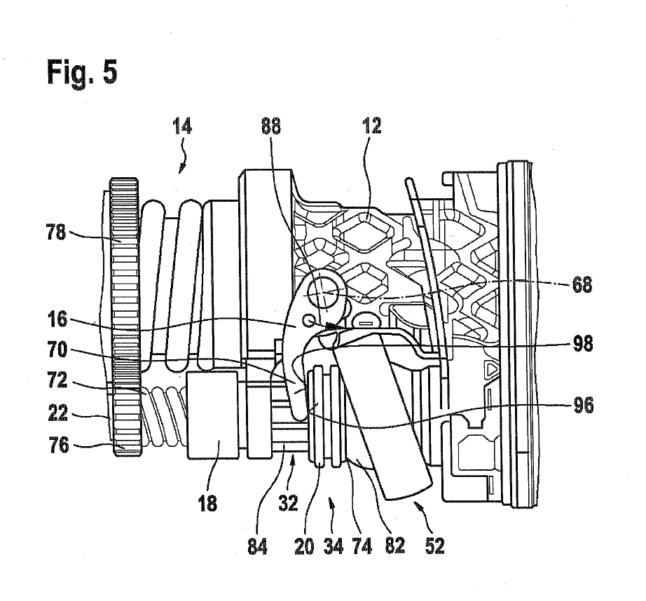

FIG. 5 in turn shows a drilling position of the gear unit 14 of the handheld power tool 10. For switching the gear unit 14 of the handheld power tool 10 from the impact drilling position, shown in FIGS. 2 and 3, to a gear position in which the gear unit 14 makes solely a drilling mode possible, the switch means 16 is pivoted, via the actuating element 28 not shown here, in the direction of rotation 88, that is, counterclockwise about the axis 68. Because of the pivoting motion, the switch means 16 moves out of its position of equilibrium, and a surface 96 of the extension 70 comes into contact with a surface 98 of the switch bush 20. By means of the contact pressure thus exerted, the switch bush 20 is moved in the axial direction 24, counter to the spring force of the spring 74, on the shaft 22 in the direction of the bearing body 82 of the tumbling gear 52. As a consequence, the spring 74 is compressed, and the inner set of teeth of the switch bush 20 becomes disengaged from the rotary slaving contour 84. As a result, the bearing body 82 or the tumbling gear 52 is decoupled from a rotary motion of the drive shaft, and no transmission of a torque to the tumbling gear 52 and thus to the impact mechanism 48 takes place, as a result of which the tool does not receive any impact pulse. An engagement of the switch bush 18 remains unaffected, and as a result the rotational torque transmission to the hammer tube 46 or the tool holder 42 and the tool continues to take place via the shaft 22, and a drilling mode of the gear unit 14 is made possible.

A movement of the switch bush 20 backward in the axial direction 24 in the direction of the switch bush 18 functions analogously to the movement backward of the switch bush 18 as a result of the spring force of the spring 74.

1-11. (canceled)

12. A handheld power tool, in particular a rotary and/or chiseling hammer, having an intermediate flange and a gear unit which has a switch means supported on the intermediate flange, wherein the switch means is provided for switching among at least three gear stages of the gear unit.

13. The handheld power tool as defined by claim 12, wherein the gear unit has at least one switch bush, which is movable by means of the switch means.

14. The handheld power tool as defined by claim 13, wherein the gear unit has a further switch bush.

15. The handheld power tool as defined by claim 14, wherein the at least one switch bush and the further switch bush are supported on one shaft.

16. The handheld power tool as defined by claim 14, wherein one of the at least one switch bush and the further switch bush is movably supported in an axial direction.

17. The handheld power tool as defined by claim 15, wherein one of the at least one switch bush and the further switch bush is movably supported in an axial direction.

18. The handheld power tool as defined by claim 12, wherein the switch means has a contact region for application of an actuating element.

19. The handheld power tool as defined by claim 12, wherein a bearing point is provided for rotational support of the switch means on the intermediate flange.

20. The handheld power tool as defined by claim 14, wherein the switch means engages an intermediate space between the at least one switch bush and the further switch bush.

21. The handheld power tool as defined by claim 15, wherein the switch means engages an intermediate space between the at least one switch bush and the further switch bush.

22. The handheld power tool as defined by claim 16, wherein the switch means engages an intermediate space between the at least one switch bush and the further switch bush.

23. The handheld power tool as defined by claim 20, wherein an engagement with the intermediate space is effected without force in at least one gear stage.

24. The handheld power tool as defined by claim 21, wherein an engagement with the intermediate space is effected without force in at least one gear stage.

25. The handheld power tool as defined by claim 22, wherein an engagement with the intermediate space is effected without force in at least one gear stage.

26. The handheld power tool as defined by claim 13, wherein a spring unit is provided for subjecting the at least one switch bush to a spring force in at least one mode of operation.

27. The handheld power tool as defined by claim 14, wherein a spring unit is provided for subjecting the at least one switch bush to a spring force in at least one mode of operation.

28. The handheld power tool as defined by claim 15, wherein a spring unit is provided for subjecting the at least one switch bush to a spring force in at least one mode of operation.

29. The handheld power tool as defined by claim 26, wherein in the at least one mode of operation, the spring force acts counter to a switching force.

30. The handheld power tool as defined by claim 27, wherein in the at least one mode of operation, the spring force acts counter to a switching force.

31. The handheld power tool as defined by claim 28, wherein in the at least one mode of operation, the spring force acts counter to a switching force.
